(19) United States
(12) Patent Application Publication
(10) Pub. No.: US 2014/0310107 A1
(43) Pub. Date: Oct. 16, 2014

(54) SYSTEM AND METHOD FOR ADVERTISEMENT OF REAL ESTATE

(71) Applicant: John C. Davison, Phoenixville, PA (US)

(72) Inventor: John C. Davison, Phoenixville, PA (US)

(21) Appl. No.: 14/248,880

(22) Filed: Apr. 9, 2014

Related U.S. Application Data
(60) Provisional application No. 61/810,574, filed on Apr. 10, 2013.

(51) Int. Cl. G06Q 30/02

(52) U.S. Cl. CPC G06Q 30/0276
USPC 705/14.72

(57) ABSTRACT

A system is described for recording and editing real estate advertisements through a hand-held computing device, posting the commercial for public access via the internet and for retrieval and playing back of the advertisements through similar devices.

### CROSS-REFERENCE TO RELATED APPLICATIONS

This utility application claims priority to provisional application Ser. No. 61/810,574 filed on Apr. 12, 2013 entitled “System and Method for Advertisement of Real Estate.” The entire disclosures of the provisional application is included herein by reference.

### FIELD OF INVENTION

The present invention relates to advertisement of real estate and more specifically to the use of mobile electronic device for creation and display of said advertisement.

### BACKGROUND OF THE INVENTION

Existing Utilization of Real Estate Commercials

Multimillion-dollar properties typically have commercials produced for them. These commercials typically require creation by professional studios. The goal of these productions is to increase visibility of properties and prequalify visitors before they visit these larger estates.

The goal of the disclosed real estate app is the same. By providing these commercials, property owners and realtors are able to increase the perceived value of a property by setting a tone and mood. This tone and mood is not attainable using a traditional catalog or magazine approach to featuring properties.

### SUMMARY OF THE INVENTION

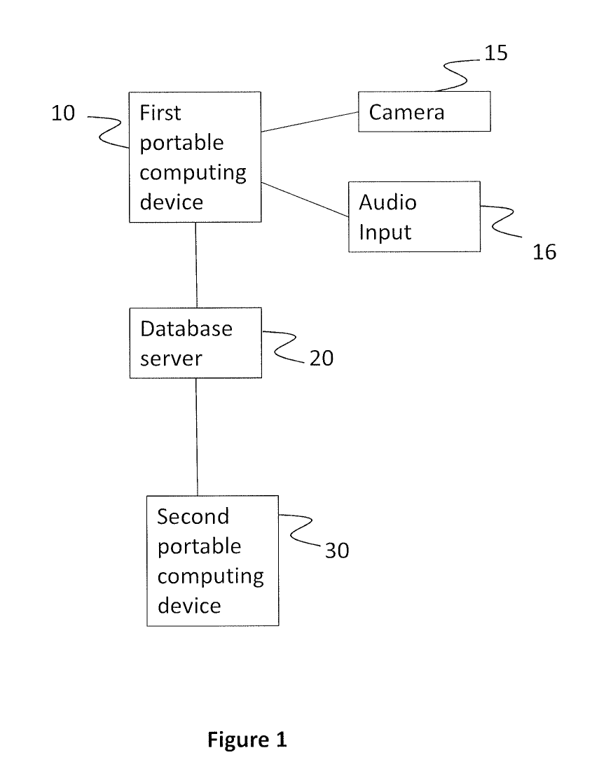

In an embodiment shown in FIG. 1 the invention comprises a system for capturing and displaying a real estate advertisement. The system includes a first portable computing device 10 comprising: a user interface, a display, a camera 15 and an audio input 16. The first portable computing device is configured to access to voice recognition, GPS and mapping, a data map provider, and a database server 20. There is also a second portable computing device 30 comprising: a user interface, a display and wireless access to the database server. The first portable computing device 10 is configured to record at least one of images or text and audio describing the real estate and the first portable computing device is further configured to uploading said images or text and audio to the database server 20. The second portable computing device 30 is configured to retrieve the images, text and audio from the database server 20.

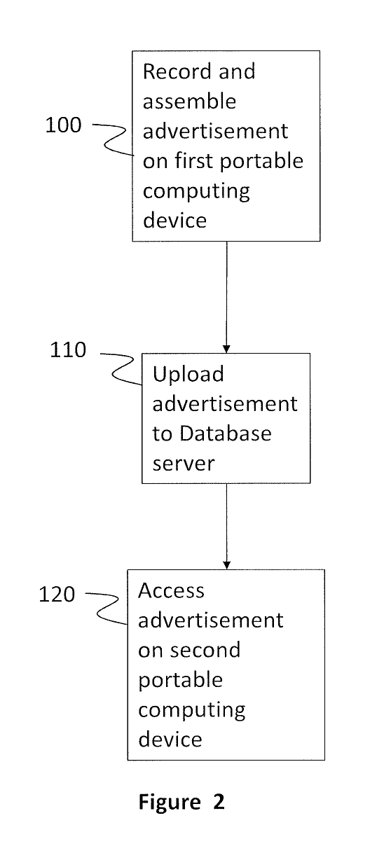

In a further embodiment shown in FIG. 2 the invention comprises a method for advertising real estate comprising the steps of recording on a first portable computing device information describing said real estate 100; storing the recorded information describing said real estate on a database server 110; and providing access for a user to the recorded information via the database server; and accessing by the user the recorded information on a second portable computing device 120.

In a further embodiment of the method, the recording is performed in modules associated with portions of the real estate.

In a further embodiment of the method, the recording includes photographs of the real estate.

In a further embodiment of the method, the recording includes video of the real estate.

In a further embodiment of the method, the recorded information is accessed by said user through a commercial real estate broker.

In a further embodiment of the method, recorded information is accessed by said user through an aggregated real estate listing service.

### DETAILED DESCRIPTION OF THE INVENTION

Description of the Figures:

FIG. 1 is block diagram of an exemplary system for recording and accessing real estate advertisements; and

FIG. 2 is a flow diagram of an exemplary method of recording and accessing real estate advertisements.

Summary of Application Suite

This application suite will provide sellers and buyers of products with the following functionality: 1. Allow users to create professional-like commercials for selling their properties. 2. Allow “buyer” users to easily find properties using voice recognition queries. 3. Allow for integration with one or more providers of product Meta data. An example of this Meta-data would be MLS data for houses. The usage of this Meta-data could be to display additional information above and beyond information entered by “seller” users.

Components

The applications developed will make use of various software components developed by third parties. These components will provide the following functionality to the application: Voice Recognition, GPS/mapping, Data Map Provider, Database Server, Middleware Platform such as ASP.net or PHP.

Video Rendering

This application may take advantage of components for video rendering, which processes the video on a server or on the phone device itself.

Device Support

Support initially would target the iPhone® and Android® smart phone platforms.

Support for tablet interfaces is also contemplated.

Language

The application will initially target English-speaking individuals. The application will be capable of supporting other languages.

The goal of the commercial application is to allow owners of properties to easily create commercials (visual tours) for their properties. Although currently on the market, the ability to create virtual tours and commercials is cost prohibitive for many homeowners.

Existing Utilization of Real Estate Commercials

Multimillion-dollar properties typically have commercials produced for them. These commercials typically require creation by professional studios. The goal of these productions is to increase visibility of properties and prequalify visitors before they visit these larger estates.

The goal of the disclosed real estate app is the same. By providing these commercials, property owners and realtors are able to increase the perceived value of a property by setting a tone and mood. This tone and mood is not attainable using a traditional catalog or magazine approach to featuring properties.

Bringing Real Estate Commercial Development to the Masses

The application will not require a large production team. The only thing necessary is a smartphone, a house, and 30-60 minutes.

Downloading the Application

Buyers will have the ability to download the application from their phone providers respective application stores. There are various marketplaces, which can be utilized to sell android applications; the iPhone has a centralized store for sale of their applications (App Store).

These application stores typically allow application purchases. Application purchases can be made within an application's functionality. Sellers will have the same mechanism for downloading the application. The applications will be one and the same.

Technologies described here are not only limited to real estate products; they can be incorporated into the sale of any type of product that would benefit from searching and visual demonstrations.

Download

The first thing a Seller does is download the application.

Tour

The application will provide a quick high-level tour of how to utilize the application. The goal of the application from the seller's perspective is the production and listing of the commercial to be accessible by “buyer” users of the application.

This quick tour at a high-level will show sellers how to use the application. It will give a few examples of what the commercials could potentially look like. These tours would be featured on a social video platform such as YouTube to allow for larger exposure of the application to potential users.

Application Mode Choice

After presented with a brief tour, users will have the option of using the application in tutorial mode or expert mode. Users will easily be able to toggle between these modes using the main menu, which is always featured at the bottom of the application. Expert mode will allow users to use their own judgment when videoing properties, Recommended mode will be the tutorial mode, which guides the user on how to create an effective commercial.

Modules

The commercial development process will be made up of modules. There will be modules developed for every major feature of a house. These modules include but are not limited to Front door, Bedroom, Master bedroom, Living room, Kitchen, Pantry, Basement, Deck, Porch, Garage, Laundry room, Closet Hallway, Bathroom Backyard, Front yard, Side of house, Front of house and Back of house

Modules will first provide an explanation of what is expected of the user. In some cases it may be speaking into the microphone, in other cases it might be videoing a room. The module will be able to display a demonstration of how that module should be used. An example of this would be the front door module.

The front door module could prompt users to take a photo of the front door. The front door module could also ask for a video of the door being opened by a person. The module could demonstrate this by showing a video, or a picture with voice, or text instructions.

Other Modules Uses

Modules can be developed not only for real estate but also for any other type of product. Modules will be constructed using XML and multimedia content. Input, which is prompted by the module, can be any form of popular multimedia content.

Templates

Administrators of the application will be able to create templates. Templates are sequences of modules, which can be decorated with themes and music. If a person indicates that they live in a high-rise, there is no reason to present them with the front yard module.

Meta Data Association

After completing all modules in a template or sequence information links from a

Meta-provider, such as an MLS provider, and will be associated with the property or product. This meta data will be formatted to display within the commercial. In the case of the MLS they have certain requirements that require any application data provided from another source be highlighted. This would be handled in a disclaimer before and after watching the commercial.

Finishing Touches

At the end of completing all modules, sellers will also have the ability to select other sequences or templates. This will allow them to customize the music and appearance. Music and imagery will be limited to those provided by the application.

Publishing

After customizing the appearance of the commercial, sellers will have the option of paying to download the commercial for use in any way that they want or, for a fee, have the commercial posted for searching in the application. These fees can be paid within the application itself. The home search application will utilize voice recognition for simple home search queries. Exemplary queries that can be supported are:

Search for homes within 50 miles

Search for townhomes within 50 miles

Search for homes within 50 miles that have three bathrooms

Additional queries can be programmed into the system on an as needed basis. This voice recognition technology will not be developed from scratch, but will utilize third-party components, which will to be identified.

The home search application will also take advantage of a GPS component, which will highlight properties within a user's proximity. Properties that show commercials will be featured above all other properties.

This application will provide traditional real estate search functionality such as searching by MLS data point criteria.

What is claimed is:

1. A system for capturing and displaying a real estate advertisement comprising:
A first portable computing device comprising:
a user interface,
a display, and
a camera,
said first portable computing device configured to access to voice recognition, GPS and mapping, a data map provider, and a database server,
a database server and
a second portable computing device comprising:
a user interface,
a display and wireless access to said database server,
wherein said first portable computing device is configured to record at least one of: images or text and audio describing the real estate
said first portable computing device is further configured to uploading said images or text and audio to said database server and
wherein said second portable computing device is configured to retrieve said images, text and audio from said database server.

2. A method for advertising real estate comprising:
recording on a first portable computing device information describing said real estate;
storing said recorded information describing said real estate on a database server; and
providing access for a user to said recorded information via said database server; and
accessing by said user said recorded information on a second portable computing device.

3. The method of claim 2, wherein said recording is performed in modules associated with portions of the real estate.

4. The method of claim 2, wherein said recording includes photographs of the real estate.

5. The method of claim 2, wherein said recording includes video of the real estate.

6. The method of claim 2, wherein said recorded information is accessed by said user through a commercial real estate broker.

7. The method of claim 2, wherein said recorded information is accessed by said user through an aggregated real estate listing service.
